(19) United States
(12) Patent Application Publication
(10) Pub. No.: US 2007/0081900 A1
(43) Pub. Date: Apr. 12, 2007

(54) Method for the production of a leadthrough in a fibre compound material, as well as a rotor blade for a wind energy facility with a leadthrough

(75) Inventor: Daniel Nies, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Nordex Energy GmbH, Norderstedt (DE)

(21) Appl. No.: 11/529,090

(22) Filed: Sep. 28, 2006

(30) Foreign Application Priority Data
Oct. 6, 2005 (DE) 10 2005 047 959.6

(51) Int. Cl. B64C 27/46

(52) U.S. Cl. 416/224

(57) ABSTRACT

A method for the production of a leadthrough in a fibre compound material for a rotor blade, with the following procedure steps: an opening free of fibres (12) is provided in a half-finished fibre product such that the fibres run around the opening (12), the half-finished fibre product is processed into a fibre compound material by adding a matrix material, and the leadthrough is put in place through the opening in the half-finished fibre product.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method for the production of a leadthrough in a fibre compound material for a rotor blade. It is also related to a rotor blade for a wind energy facility with a leadthrough through a rotor blade wall.

A leadthrough in the rotor blade wall serves as a through hole for the installation of component parts, for instance, which extend from the interior of the rotor blade through the shell towards the outside. Such component parts are receptors for the lightning protection of the wind energy facility, cross bolts for fixing the rotor blade, means for indicating danger, sensors and draining equipments, for instance. Yet, the leadthrough in the rotor blade wall can also serve as an access opening for putting in place or removal of objects like trimming weights, for instance, or it may have other assignments.

From DE 103 24 166 B4, the entire contents of which is incorporated herein by reference, it is known to provide through holes in the region of the blade root, which run crosswise to the longitudinal direction of the rotor blade. For a favourable force introduction from the cross bolt into the fibre-reinforced epoxy resin compound material of the rotor blade, it is proposed to perform a cross section enlargement of the wall material at the blade root.

From WO 2005/026538, the entire contents of which incorporated herein by reference, a lightning protection for the rotor blade of a wind energy facility is known. For this purpose, a lightning receptor is guided through a leadthrough in the shell of the rotor blade and is connected to earth in the inner space of the rotor blade. In order to avoid weakening of the fibre compound material in the rotor blade, it is proposed to place the leadthrough for the lightning receptor into the rotor blade tip as far as possible.

### BRIEF SUMMARY OF THE INVENTION

The present invention is based on the technical goal to provide a leadthrough in a rotor blade which extensively avoids any weakening of the fibre compound material by simple means.

In the method according to the present invention, a leadthrough in a fibre compound material for a rotor blade is produced. In particular, fibre reinforced epoxy resin compound materials, for instance, have succeeded as lightweight but anyway robust materials for the production of rotor blades of wind energy facilities. In the method according to the present invention, an opening free from fibres in a half-finished fibre product is provided in a first step, such that the fibres run around the opening. Thus, the opening in the half-finished fibre product is not made by punching out, cutting or other methods in which the fibres are severed at the wall of the hole. Instead, in the method according to the invention, an opening is made in the half-finished fibre product from which the fibres are squeezed out.

During the following processing, the half-finished fibre product is cast with matrix material in the production of the fibre compound material, and is processed to the fibre compound material. The leadthrough is put in place via the opening in the half-finished fibre product thereafter by boring or milling, for instance. Besides to the putting in of the leadthrough into the fibre compound material, as an alternative, before the casting with the matrix material, a body can be inserted into the opening in the half-finished fibre product and incorporated with the fibre compound material. The particular advantage of the method according to the invention is that any severing and shortening of the fibres for the leadthrough is avoided, and thus a weakening of the material does not take place. The leadthrough produced according to the present invention has a high strength of the face of the hole.

In one possible realisation of the method according to the present invention, the leadthrough is bored or milled into an incorporated auxiliary body. Usually, a tissue or a laid material or a fibre mat from fibres of one or several kinds is provided as the half-finished fibre product. The auxiliary body may also be removed again from the fibre compound material. For this purpose, it is practically provided with a release agent along its perimeter.

Preferably, a cylindrical or conical tool in the manner of a thorn is used for bringing in the leadthrough into the half-finished fibre product, in order to form the leadthrough with the desired diameter.

Rotor blades are preferably produced in a so-called sandwich construction. In this, a core is provided on both sides with a fibre compound material. The core has a through hole, which accommodates the body, as the case may be. The leadthroughs in the fibre compound material are aligned with the through hole in the core. The core material can consist of plastics, for instance. However, it is also possible to use other materials for the core, like wood e.g., balsa wood in particular.

Besides to the sandwich structure from laid material, core material, laid material, full laminates can also be provided. The full laminate consists of several laid materials, which are laminated with each other.

The rotor blade according to the present invention is provided for the use in a wind energy plant. The leadthrough extends through the wall of the rotor blade, which has a fibre compound material. According to the invention, the fibres run in the fibre compound material such that an opening free of fibres is formed. Preferably, the wall of the rotor blade consists of a core, which bears the fibre compound material on both sides thereof, the core having a through hole for the leadthrough. Preferably, an auxiliary body is inserted into the through hole in the core, the material of which corresponds to the material of the core.

In a practical realisation, the auxiliary body is realised to be thicker than the core in the region of its through hole. In this way, it is made sure that the auxiliary body projects also into the leadthrough of the half-finished fibre product when the fibre compound material is fixed. Through this, it is made sure that the leadthrough remains free of fibres at the work with the matrix material, an epoxy resin, for instance. Preferably, the auxiliary body projects somewhat over the fibre compound material on the core, too.

In a particularly preferred realisation, a lightning conductor is provided in the rotor wall, which is arranged in the leadthrough of the rotor blade and which is electrically conductive connected with an earthing. In order to avoid damage of possibly conductive fibres in the fibre compound material, the lightning conductor in the leadthrough is arranged in an insulator, the lightning conductor projecting as far as into the inner space of the rotor blade in this. Preferably, the lightning conductor runs out into a lightning protector body, which is arranged on the inner side of the rotor blade wall and has an accommodation for the lightning conductor. The lightning protector body is connected to earth via electric lines.

### BRIEF DESCRIPTION OF SEVERAL VIEWS OF THE DRAWINGS

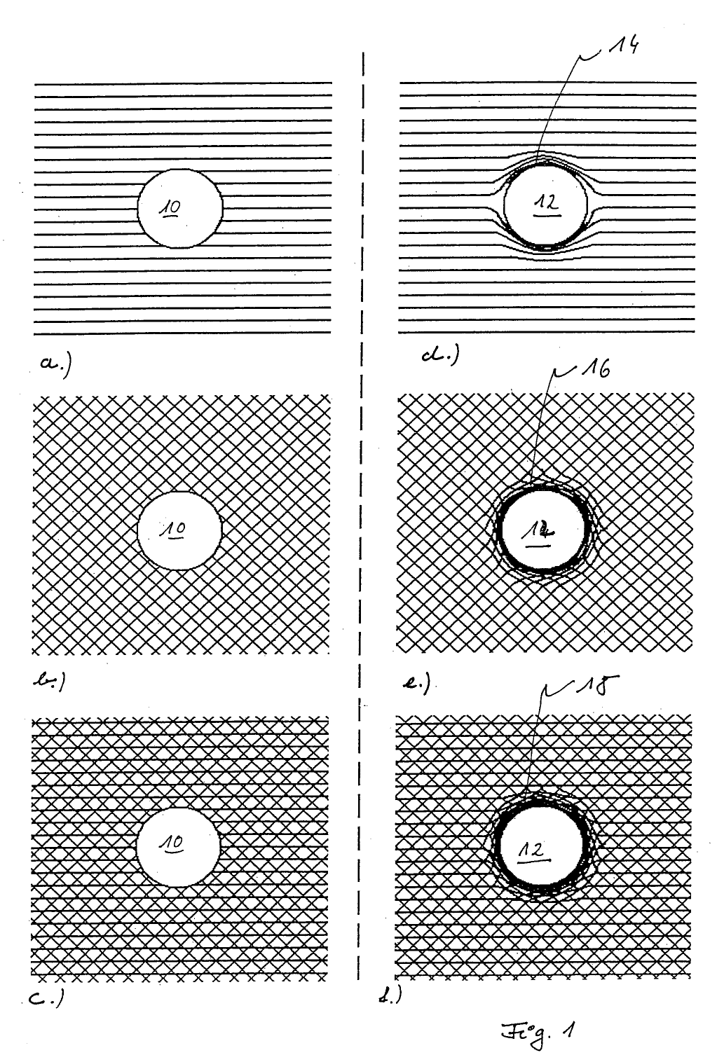

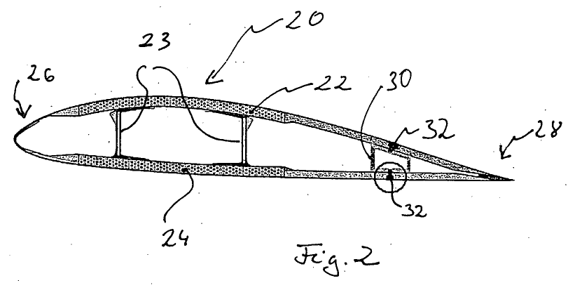

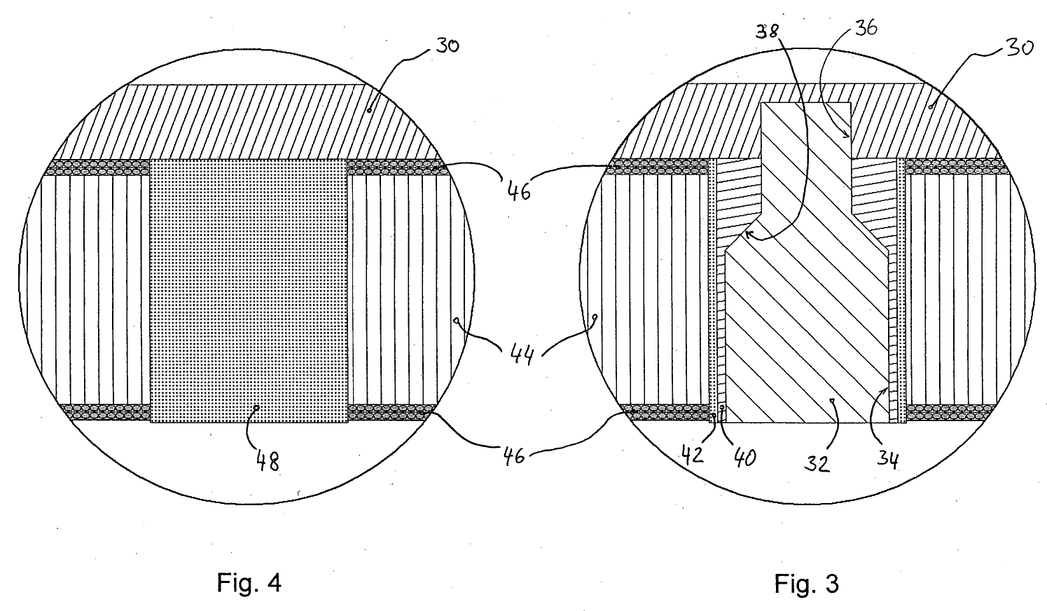

The leadthrough according to the present invention is explained in more detail by means of an example in the following. FIGS. 1a-f show different orientations of the fibres in a laid material, FIG. 2 shows a rotor blade in a cross section with a lightning protection equipment, FIG. 3 shows a lightning receptor in the leadthrough according to the present invention, and FIG. 4 shows a leadthrough through the rotor blade wall.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated FIG. 1 shows on its left side different fibre tissues, the fibres of which were interrupted by the belated making of a leadthrough 10.

FIG. 1a shows a unidirectional (UD) course of the fibres, in which the fibres run substantially parallel. FIG. 1b shows a biaxial arrangement, in which the fibres run in two preferential directions, which are vertical with respect to each other. FIG. 1c shows a triaxial orientation of the fibres, in which the fibres run in three directions. It is common to all the three orientations of the fibres that the fibres in the wall of the hole are interrupted by the leadthrough 10. Therefore, the interrupted fibres can no more take up the forces in the region of the leadthrough, through which a local exorbitant increase of the forces takes place in the material. On its turn, this increased mechanical stress of the rotor blade material shortens the predictable lifetime of the rotor blade. In contrast, the fibres 14, 16, 18 are only squeezed out of the opening in the realisations according to FIG. 1d-f. The fibres run around the through hole 12, without projecting into the same. In a fibre reinforced compound material, the represented course of the fibres leads to a significantly improved strength of the face of the hole in the rotor blade wall.

FIG. 1d shows a fibre laid material corresponding to FIG. 1a again, in which the fibres run unidirectionally in substantially one direction. FIG. 1e corresponds to FIG. 1b and shows the compacted fibres 16 in the surrounding of the leadthrough 12 in an exemplary manner. FIG. 1f shows the triaxial orientation of the fibres in the tissue, which leads to a further increased compactness of the fibres 18.

FIG. 2 shows a cross section through a rotor blade 20 in an exemplary manner, with a top shell 22 and a bottom shell 24. The two half-shells 22, 24 are connected with each other in the region of the blade nose 26 and on the rotor blade rear edge 28. Between the half shells 22 and 24, bridges 23 are arranged, which stabilize the rotor blade.

In the rear region of the rotor blade, a lightning protector case is set between the half shell 22 and the half shell 24. The lightning protector case 30 is made of metal and is connected to earth via electric lines (not shown).

The lightning protector case 30 is connected with lightning receptors 32 on the upper side of the blade as well as on the lower side thereof. FIG. 3 shows a detail view of the lightning receptor 32 in the bottom shell of the rotor blade. The lightning receptor made from metal has a cylindrical body portion 34 and a second cylindrical body section 36 having a smaller diameter than the first body portion. First and second body portion are connected with each other via a cone-shaped portion 38. The lightning receptor 32 is cast into an insulating material 40 and is connected with the lightning protector body 30 in its second cylindrical portion 36. The insulating material 40 is cast into a cylindrical jacket body 42. The cylindrical jacket body 42 is formed by the bored-through auxiliary body. The core 44 is provided on both sides with a fibre reinforced plastic material 46. The fibre reinforced plastic material consists of an epoxy resin, which was reinforced by a fibre laid material. In this, the fibre laid material has a leadthrough, through which the cylindrical jacket body 42 and the lightning receptor 32 project.

FIG. 4 shows the assembly of the rotor wall before the lightning receptor 32 is inserted in a detail view, for the sake of better understanding. The wall of the rotor blade has a core material 44, which is covered with a fibre reinforced compound material on both sides. The core 44 has a through hole, into which an auxiliary body 48 is inserted. Preferably, the auxiliary body 48 is made from the same material as the core material. When wood is used as a material for the core, a body from plastic material is preferably used as the auxiliary body 48. The auxiliary body 48 is incorporated into the fibre reinforced compound material 46.

In order to put in place the insulating material 40 and the lightning receptor 32 thereafter, a bore is made into the incorporated auxiliary body 48, so that the cylindrical jacket body 42 remains in the through hole of the core material. Alternatively, it is also possible to remove the auxiliary body 48.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method for the production of a leadthrough in a fibre compound material for a rotor blade, with the following procedure steps: an opening free of fibres (12) is provided in a half-finished fibre product such that the fibres run around the opening (12), the half-finished fibre product is processed into a fibre compound material by adding a matrix material, and the leadthrough is put in place through the opening in the half-finished fibre product.

2. A method according to claim 1, characterised in that a body is inserted into the free opening before the matrix material is added.

3. A method according to claim 2, characterised in that the body is incorporated in the fibre compound material.

4. A method according to claim 2, characterised in that an auxiliary body is provided as the body, through which the leadthrough is bored or milled.

5. A method according to claim 2, characterised in that an auxiliary body is provided as the body, which is removed from the fibre compound material after the addition of the matrix material.

6. A method according to claim 5, characterised in that the body is provided with a release agent on its perimeter.

7. A method according to claim 1, characterised in that the free opening is cast together with the compound material and the leadthrough is bored or milled through the compound material.

8. A method according to claim 1, characterised in that a tissue or a laid material or a fibre mat from fibres of one or several kinds is provided as the half-finished fibre product.

9. A method according to claim 1, characterised in that a cone-shaped tool is introduced into the half-finished fibre product in order to produce the opening for the auxiliary body.

10. A method according to claim 1, characterised in that a core is provided on both sides with the fibre compound material, the openings in the half-finished fibre product overlaying congruently each other on both sides of the core.

11. A method according to claim 1, characterised in that the half-finished fibre product is processed into a full laminate.

12. A rotor blade for a wind energy facility with a leadthrough through a rotor blade wall, which has a fibre compound material characterised in that the fibres in the fibre compound materials run such that an opening free of fibres is provided for the leadthrough.

13. A rotor blade according to claim 12, characterised in that the wall of the rotor blade has a core which bears the fibre compound material on both sides, the core having a through hole for the leadthrough which is congruent with the openings in the half-finished fibre product.

14. A rotor blade according to claim 13, characterised in that a body is inserted into the through hole in the core.

15. A rotor blade according to claim 14, characterised in that the leadthrough runs as a bore through the body.

16. A rotor blade according to claim 12, characterised in that the rotor blade wall is realised as a full laminate from a half-finished fibre product.

17. A rotor blade according to claim 12, characterised in that at least one lightning conductor (32) is provided in the rotor blade wall, which is arranged in the leadthrough of the rotor blade and is electrically conductive connected with an earthing (30).

18. A rotor blade according to claim 17, characterised in that the lightning conductor is arranged in an insulating material (40), the lightning conductor projecting into the inner space of the rotor blade.

19. A rotor blade according to claim 17, characterised in that the lightning conductor runs out into a lightning protector body, which is arranged on the inner side of the rotor blade wall and has an accommodation for the lightning conductor (32) which projects into the inner space.

20. A rotor blade according to claim 19, characterised in that the lightning protector body (30) is connected to earth via electric lines.
